(19) United States
(12) Patent Application Publication
(10) Pub. No.: US 2011/0041711 A1
(43) Pub. Date: Feb. 24, 2011

(54) ARTICLE COMPACTION APPARATUS

(76) Inventor: John Nickell-Lean, York (GB)

Correspondence Address: NIXON & VANDERHYE, PC, 901 NORTH GLEBE ROAD, 11TH FLOOR, ARLINGTON, VA, 22203, US

(21) Appl. No.: 12/736,558

(22) PCT Filed: Apr. 16, 2009
(86) PCT No.: PCT/GB2009/000983

§ 371 Date: Oct. 19, 2010

(30) Foreign Application Priority Data
Apr. 19, 2008 (GB) 0807177.1

(51) Int. Cl. B30B 1/00

(52) U.S. Cl. 100/214

(57) ABSTRACT

An article compaction apparatus is described which comprises a fixed compaction surface and a movable compaction surface substantially parallel to the fixed compaction surface, the movable compaction surface being movable relative to the fixed compaction surface by means of an actuation mechanism. The actuation mechanism comprises at least one scissor jack mechanism arranged for horizontal operation within the apparatus which may also utilize a compaction zone which may expand in one dimension during the compaction cycle. Compacted articles are removed from the compaction zone under the action of gravity.

### FIELD OF INVENTION

The present application relates to various aspects of an apparatus for crushing articles for waste disposal or recycling, such as cans or bottles or Tetrapak® containers and the like. In particular, but not exclusively, the present application relates to an apparatus which is relatively small and portable and which is suitable for use in the disposal of waste in the home or in small business premises such as restaurants, public houses and the like.

### BACKGROUND ART

Traditionally, waste has been disposed of by dumping in landfill sites or at sea. However, with increasing awareness of the environmental impact of such dumping and a reduction in the amount of available land suitable for use as land fill sites, ways of reducing the amount of waste for disposal have been developed.

Recently there has been an increased awareness of the benefits of recycling, in particular the recycling of aluminium or steel cans and plastic or glass containers such as bottles and jars etc: To encourage recycling activities it is known to provide receptacles in public places in which people can deposit empty glass containers or aluminium cans for recycling. However many people are reluctant to make the effort required to use these collection facilities.

Some local authorities provide householders with special containers in which to collect articles for recycling at home for subsequent collection by the authority. However, there is problem for many householders in storing these containers, which in any case are often not large enough to hold all the bottles or other containers used by the householder between authority collections.

There are also problems associated with the volume of waste for disposal. Householders and business are often provided with special bins in which their waste must be placed for collection. Some local authorities will refuse to collect waste that cannot be accommodated in the bins provided, meaning that special arrangements must be made to dispose of any excess waste. Empty containers such as cans, plastic bottles and the like take up a large amount of the available space in the bins provided; most of the available space is effectively being taken up by the empty volume of each container. Reducing the volume of such containers by crushing them can help to reduce the overall volume of waste for disposal.

Machines for crushing waste to reduce its volume and for breaking up glass containers have been proposed in the past. However most of these have been developed for large scale industrial applications and are not suitable for use in the home or in small business premises. Those machines that have been proposed for use in the home have not proved to be very efficient, clean or safe.

United Kingdom Patent Application GB2245209 discloses a can crusher, which is operated by a hand lever and incorporates an interlock between the lever and the sliding door to the crushing chamber to ensure that the door is closed against a spring bias before crushing begins and cannot be opened during crushing. The interlock involves a disc that rotates with the lever and intersects the trap of the door. The lever can move from its rest position only when an aperture in the closed door is in register with the disc and the door can move from closed only when the lever in its rest position an aperture in the disc is aligned with the track. A longitudinally inserted can is crushed laterally by a plate which has a narrow edge for folding the can bottom up behind the plate to drop from the chamber on release of crushing pressure.

Published UK Patent Application GB2271952 discloses a can crusher having open topped chamber, a lockable access member and a powered ram. A can is placed in the chamber and the access member is closed and locked by solenoid bolts. The ram is then moved towards the wall crushing the can in its path. The crushed can then drops into a chute for onward disposal. After the ram returns to its original position the bolts are released allowing the access member to be opened. The ram may contain a magnet to retain steel cans and drop them through an alternative exit aperture. Alternatively a magnetically activated deflection flap may be employed.

Published UK Patent Application GB2290494 discloses a machine for disposing of filters, each filter comprising a casing containing the filter element. The machine comprises a first means for cutting open the casings of the filters and a second means for crushing the open casings, the first and second means being operable simultaneously in respective filters. Operation of the first and second means may be initiated when an access door is closed and stopped when the door is opened. Consequently an operator is protected from the moving parts of the machine when it is working.

Published UK Patent Application GB2301056 discloses a compressing apparatus for compressing empty containers comprising a cabinet, a door pivotally mounted on the cabinet, compression means for effecting compression of a container positioned in the cabinet and a control system for controlling operation of the compression means. The pivotal mounting of the door incorporates a cam, which operates switching means such that closure of the door and its operation of the compression means and opening of the door prevents such operation. The switching means is provided in a housing on the top of the cabinet so the door must be closed before the compression means can effect a working cycle.

Published United Kingdom Patent Application GB2409419 discloses an article crusher, which comprises a housing and a crushing chamber within the housing for receiving an article to be crushed. The chamber has a pair of jaws with substantially parallel opposed contact surfaces and drive means for closing the jaws so that the contact services apply compressive forces to an article in the chamber, the drive means being arranged to move the jaws relative to one another in a generally horizontal plain, whilst maintaining the contact surfaces substantially parallel to one another.

Published European Patent Application No. 0568423 discloses an apparatus for compacting empty containers comprising a base, a body with a bottom, a lateral awl on a superstructure, a piston with a head and a skirt, a drive means for causing this piston to slide in the body, a control and a compacting device with jaws. The lateral awl is pierced through by an orifice in the vicinity of the bottom is a clip with a door.

Published European Patent Application EP0685096 discloses a device for compacting returnable packages such as beverage cans or bottles, which comprises an in-feed unit, a checking unit and a compacting unit. The compacting unit comprises a fixed, rigid wall, a moveable rigid wall as well as means for displacing the moveable wall towards the fixed wall the walls being substantially parallel also during the displacement of the moveable wall towards the fixed wall.

Published European Patent Application EP1050708 discloses a control device for the control of safety functions of a machine susceptible of being dangerous. The controller has at least one safety switch for monitoring the position of a door that closes the hazardous region of the machine. The safety switch produces a signal for evaluation by evaluation electronics mounted at a point in the main body of the machine a distance from the safety switch. An independent claim is also included for a method of controlling safety relevant functions of a hazardous machine.

Published International Patent Application WO2007/149468 discloses an apparatus and method for compacting recycled items. The apparatus is a manually operated compactor comprising an upper side defining a first opening configured to receive an item to be compacted and a second opening configured to receive an item that is not to be compacted, a first compacting element, a second compacting element, a foot activated lever configured to urge at least the first compacting elements towards the second compacting element when pressed downward, allocation for removable container to receive an item compacted by the first and second compacting elements positioned lower than the first and or second compacting elements.

U.S. Pat. No. 6,141,954 discloses a multi-unit, automatic machine for compaction, packaging, and disposal of plural types of material such as newspaper, plastic containers, glass bottles, aluminum cans, or other household and commercial waste. The material is crushed and compacted as a movable container is moved upwards towards a static container thus reducing the volume of the material between them. The actuation system consists of double scissors member mechanism and pneumatic actuator connected in between members of the mechanism, thus amplifying the travel of the actuator.

U.S. Pat. No. 3,863,561 discloses a top-loading trash compactor primarily for institutional use and comprising a counter top height cabinet with two cubicles with trash containers therein, the cabinet top panel having two trash loading hatchways therein, one for each cubicle. The cabinet top panel is spaced above the containers to provide a ram shuttle way below the panel top and above the containers. A single ram is mounted in the shuttle way for shuttle movement from one cubicle to the other. When the ram is in one cubicle, it is utilized to compact trash previously loaded into the container in that cubicle. This exposes the other container to receive trash-loaded thereinto through its open hatchway. The ram carries a hatch cover or shield to close the hatchway above the cubicle in which the ram is working and opens the hatchway above the other cubicle.

U.S. Pat. No. 4,100,850 discloses a trash compactor having a rotatable lead screw and stationary nut for raising and lowering the compacting ram by rotation of the screw. The drive mechanism may be used in a trash compactor having an extensible linkage of the scissors jack or lazy tongs type in which the lead screw is journalled in one of the intermediate junction points of the linkage. The housing containing the nut is located at the other of the junction points so that rotation of the screw extends and retracts the linkage.

Published European Patent Application EP1148991 discloses a refuse compactor having a housing for containing a garbage receptacle, and a compression unit for compacting the refuse in the compaction unit from time to time. The compaction unit used is a scissors mechanism having one side of the scissors mechanism held in one plane. The scissor jack unit is arranged and operates vertically within the compactor.

There is a need, therefore, for an apparatus capable of crushing empty containers and of breaking glass containers and there is also a need for an apparatus, which is small, clean and safe enough to be used in a home or small business premises.

### DISCLOSURE OF THE INVENTION

In a first aspect the present invention provides An article compaction apparatus comprising a fixed compaction surface and a movable compaction surface substantially parallel to the fixed compaction surface, the movable compaction surface being movable relative to the fixed compaction surface by means of an actuation mechanism, wherein the actuation mechanism comprises at least one scissor jack unit arranged for horizontal operation within the apparatus. In one embodiment the compaction apparatus comprises a plurality of scissor jack units arranged for horizontal operation within the apparatus. In a further embodiment when there is a plurality of scissor jack units in the apparatus they may be in vertical (one above the other) alignment with each other within the apparatus. Alternatively, they may be in horizontal (side-by-side) alignment with each other within the apparatus. Each scissor jack unit comprises at least one scissor jack mechanism and each scissor jack mechanism comprises at least two scissor arms. In the context of the present invention horizontal operation of the scissor jack unit means that scissor arm extension within the scissor unit is in a horizontal plane within the unit. Typically this plane is perpendicular to the crushing surfaces and in the direction of the crushing action.

In one embodiment each scissor jack mechanism within the unit is driven by individual drive means. In a preferred embodiment all scissor jack mechanism within a unit are driven by a common rive means. When there is a plurality of scissor jack units these may be driven by individual drive means or preferably are driven by a common drive means. In a further embodiment the drive shaft in contact with the scissor jack unit or scissor jack units runs in parallel alignment with the compaction surfaces.

In a further embodiment the ends of the scissor arms remote from the drive shaft are in direct contact with but are not fixed to the rear of the movable compaction surface. In a further embodiment at least one of the scissor arms is in a fixed relationship with the rear of the movable compaction surface. In a further embodiment at least one of the scissor arms, which is not in fixed engagement with the movable compaction surface, is terminated with a ball bearing arrangement, which is in movable contact with the rear of the movable compaction surface. The exterior of the ball bearing presents a rotating contact surface with the rear of the movable compaction surface, with the bearing being able to rotate about a shaft associated with the end of the scissor arm and in parallel alignment with the rear of the movable compaction surface. In one embodiment the scissor arm remote from the drive shaft is engaged within guide means on the rear of the movable compaction surface. In this embodiment the ends of the scissor arms are able to move within or upon the guide means as well as exert pressure to the rear of the movable compaction surface. In a further embodiment the ends of the scissor arms may be engaged within the guide means, which may be in the form of a slot towards the rear of the movable compaction surface. In a further embodiment the ball bearing arrangement when present sits within the guide means.

In one embodiment each scissor jack unit has two scissor jack mechanisms in parallel arrangement with each other. Each scissor jack mechanism has a scissor arm, which is pivotally fixed with the rear of the movable compaction surface and a corresponding scissor arm, which is not fixed but may move in pivotal relation with the fixed scissor arm and the rear of the movable compaction surface.

In one embodiment when there are two or more scissor jack units in the apparatus the scissor jack mechanism(s) of one unit may be aligned with the scissor jack mechanism(s) of the other unit(s). This may be either vertical or horizontal alignment depending on the alignment if the units to each other. The fixed arms in each scissor jack unit secured with the rear of the movable compaction surface may be proximate to the fixed arms of the neighbouring unit or they may be fixed remotely from each other with that surface. It is preferred that they are fixed remotely from each other; in this arrangement the ends of the movable scissor arms of neighbouring units are proximate to each other.

With reference to the scissor arms the ends of these arms remote from the movable compaction surface are in cooperative engagement with a fixed static point in the apparatus. This ensures that these arm ends do not move relative to the fixed compaction surface, but are able to move relative to each other. With regards to the relationship of the scissor arms with the fixed static point in the apparatus, these may be identical with the relationship of the opposite ends of these arms with the rear of the movable compaction surface. Although the scissor arm ends associated with the fixed static point in the apparatus are in a fixed relationship with the fixed compaction surface they may be able to move relative to a drive means or one or more may be in a fixed pivotal relationship with the drive means. When one or more of the scissor ends is in fixed pivotal relationship with the drive means the corresponding end in contact with the rear of the movable compaction surface is not fixed.

In a preferred embodiment the drive means comprises a threaded screw and the movable scissor arm ends associated with the fixed static point in the apparatus are secured to the threaded screw by means of a movable screw shaft. The non-movable scissor arm ends are pivotally secured relative to the threaded screw by means of a fixed block through which the threaded screw may pass. Each scissor mechanism has a fixed middle point around which each pair of scissor arms may pivot. This fixed middle point may be a fixed middle shaft, which may secure parallel pairs of scissor arms (scissor mechanisms) to each other to form a scissor unit. In addition to the fixed middle shaft the ends of the scissor arms in parallel scissor mechanisms within a scissor unit may be secured to each other through moving shafts for moving arm ends or fixed shafts for fixed arm ends. In addition parallel scissor arms may be connected to each other at various arm locations between pivot points by means of traverse bars. When present the ball bearing arrangements may be located on the moving shafts. The fixed static point in the apparatus may have similar guide means to that associated with the rear of the movable compaction surface. The fixed static point in the apparatus may be fixed in relation to the fixed compaction surface by means of a series of interconnected fixed slats.

In a preferred embodiment the scissor unit is a double scissor unit comprising two scissor units sharing a common drive means, a common fixed static point and common guide means. In a preferred embodiment the scissor mechanisms of the adjacent units are co-planer.

In a further aspect the present invention provides An article compaction apparatus comprising a fixed compaction surface and a movable compaction surface substantially parallel to the fixed compaction surface, the movable compaction surface being movable relative to the fixed compaction surface by means of an actuation mechanism, wherein the movable compaction surface comprises a wedge shaped section at the bottom of the movable compaction surface. In a preferred embodiment the wedge shaped section is the full width of the movable compaction surface.

In a further aspect the present invention provides An article compaction apparatus comprising a fixed compaction surface and a movable compaction surface substantially parallel to the fixed compaction surface, the movable compaction surface being movable relative to the fixed compaction surface by means of an actuation mechanism, wherein the access point for waste to be compacted is located at the top of the compaction zone, the actuation mechanism comprises at least one scissor jack unit arranged for horizontal operation within the apparatus and, located below the compaction zone, is compacted waste collection means. In a preferred embodiment the compaction zone comprises means to secure the waste within the compaction zone prior to compaction and means to enable the compacted waste to pass to the compacted waste collection means. In a preferred embodiment the means to enable the compacted waste to pass to the compacted waste collection means allows the compacted waste to pass to the collection means under the force of gravity. In one embodiment the means to secure the waste within the compaction zone prior to compaction and means to enable the compacted waste to pass to the compacted waste collection means is a bottom plate upon which the scissor unit and compaction zone is supported and which separates these from the collection means. The bottom plate may comprise a hole of smaller dimension than the compaction zone, which enables communication between the compaction zone and the collection means. The dimensions of the hole are such that it is too small to allow the non-compacted waste to pass out of the compaction zone through the bottom plate and into the collection means. When the waste is compacted it is able to pass from the compaction zone under the force of gravity, after the pressure of compaction is released, through the bottom plate and into the collection means. The hole of the bottom plate is located proximate to the region in the compaction zone where compaction is complete. In a preferred embodiment the apparatus comprises a lid, which may be opened to enable access to the compaction zone and when closed ensures that the compaction zone is enclosed during compaction of waste. In a further embodiment the drive means comprises a drive motor, which is connected to the threaded screw via a gearbox arrangement or alternatively a belt and pulley arrangement. In a preferred embodiment the gearbox and or belt and pulley arrangement drives the threaded screw from the bottom of the actuation mechanism. In a preferred embodiment the drive motor is located above the gearbox or pulley and belt arrangement. This arrangement provides a compact sub-assembly comprising the actuation mechanism and drive means. In addition to the drive means and actuation mechanism the sub-assembly may further comprise control electronics such as switching and PCB control boards. In a preferred embodiment the control electronics are located behind the fixed static point in the sub-assembly and above the drive motor.

In a further aspect the present invention provides An article compaction apparatus comprising an actuation mechanism for compaction, wherein the access point for waste to be compacted is located at the top of a compaction zone having a lid for access, below the compaction zone there is located compacted waste collection means comprising a collection bin and access means to the collection bin, and switch control means to ensure that the actuation mechanism for compaction may not be activated when either'the lid, compaction waste collection means or access means to the collection means are either present and/or in the incorrect position for safe compaction. In a preferred embodiment the switch control means comprises a micro-switch which may be activated by opening and closing of the access point lid, a micro-switch arrangement, which detects that the access means to the collection bin is secure and an interlock mechanism to ensure that the removable collection means is located within the apparatus. The combination of these three features ensures that the actuation mechanism cannot be activated when either the lid is open, or the access means to the collection bin is not secure or the collection means is not present. This may be controlled and monitored with the use of appropriate control electronics. In a further embodiment the apparatus may further comprise means for detecting that the collection means is at capacity. This may take the form of control electronics with appropriate data logging, which effectively counts the number of actuations for compaction and ensures that a maximum limit is not exceeded without emptying of the collection means. In an additional or alternative arrangement the relative increase in weight of the collection bin may be detected through the use of appropriate sensors to advise the user when the collection means is at capacity. In a preferred embodiment the switch mechanism associated with the opening and closing of the access point lid comprises engagement of a portion of the lid remote from the front of the compaction apparatus with a micro-switch. Preferably the micro-switch is secured in the lid housing. In a further preferred embodiment the engagement portion of the lid is associated with one or more lid arms, which secure the lid to the lid housing and about which point the lid may rotate relative to the lid housing. In a preferred embodiment actuation and/or deactivation of the micro-switch is via rotation of the access lid. In a preferred embodiment at least one of the lid arms has a cam surface, which contacts the micro-switch during rotation of the access lid.

In a further aspect the present invention provides An article compaction apparatus comprising a fixed compaction surface and a movable compaction surface substantially parallel to the fixed compaction surface, these surfaces defining a compaction zone, the movable compaction surface being movable relative to the fixed compaction surface by means of an actuation mechanism, wherein the compaction zone is further defined by movable non-compaction surfaces aligned substantially perpendicular to the compaction surfaces in the pre-compaction state. In a preferred embodiment the movable non-compaction surfaces are arranged to move in a pivotal relationship to the compaction surfaces during the compaction cycle. In a preferred embodiment the pivotal arrangement is remote from the fixed compaction surface. In this arrangement those parts of the movable non-compaction surfaces proximate to the fixed compaction surface are able to move away from that surface during activation of the actuation mechanism and the compaction cycle. This enables the formation of a relatively compact and defined compaction zone, to enable control of the size and quantity of waste introduced to that zone, which is also able to accommodate certain dimensional expansion of the waste in that zone on compaction to enable maximum compaction. In addition and when the apparatus is switched off these movable non-compaction surfaces are able to move and therefore enable easy access to the compaction zone for cleaning and maintenance of the apparatus. The movable non-compaction surfaces act like curtains, one either side of the compaction zone, which are able to draw back from the core of the compaction zone during compaction and, when compaction is complete, may be drawn back towards the core of the compaction zone.

It should be understood that the present invention also provides for any combination of one or more of the aspects or the embodiments of each aspect separately from that aspect as described hereinbefore or hereinbelow.

### DESCRIPTION OF THE DRAWINGS

For a better understanding of the invention, and to show how the same may be carried into effect in all its aspects embodiments and combinations thereof, reference will now be made, by way of example, to various specific embodiments of the invention as shown in the accompanying diagrammatic drawings, in which:

FIG. 1 shows in perspective view of a compaction apparatus according to the present invention,

FIG. 2 shows a front view of a compaction apparatus according to the present invention,

FIG. 3, shows a side view of a compaction apparatus according to the present invention,

FIG. 4, shows a back view of a compaction apparatus according to the present invention,

FIG. 5, shows a top view of a compaction apparatus according to the present invention,

FIG. 6, shows a perspective view of a compaction apparatus according to the present invention, without the front panel, door, collection means and compaction sub-assembly,

FIG. 7, shows a perspective view of a compaction apparatus according to the present invention, without the exterior panels,

FIG. 8, is a side view of FIG. 7,

FIG. 9, is a top view of FIG. 7,

FIG. 10, is a perspective view of the compaction mechanism sub-assembly of a compaction apparatus according to the present invention,

FIG. 11, is a side view of FIG. 10,

FIG. 12, is a perspective view of the compaction mechanism sub-assembly of a compaction apparatus according to the present invention, with a fixed compaction surface removed,

FIG. 13, is the perspective view of FIG. 12, with a movable non-compaction surface removed,

FIG. 14, is the perspective view of FIG. 13, with the second movable non-compaction surface removed,

FIG. 15, is a perspective view of a scissor actuation mechanism according to the present invention,

FIG. 16, is a side view of a scissor actuation mechanism according to the present invention,

FIG. 17, is a back view of a scissor actuation mechanism according to the present invention,

FIG. 18, is an underside view of a lid assembly according to the present invention,

FIG. 19, is an underside perspective view of a lid assembly according to the present invention,

FIG. 20, is an underside perspective view of a lid assembly of FIG. 19 with the shield removed,

FIG. 21, is a perspective view of an access lid according to the present invention, and

FIG. 22, is a side view of an access lid according to the present invention in the open position and in relation to the related micro-switch.

### DETAILED DESCRIPTION OF THE INVENTION

The articles to be crushed may be glass containers such as bottles, jars and the like which are broken into pieces when crushed by the apparatus, or may be plastic containers, cardboard cartons, Tetrapak® containers or cans, and in particular steel or aluminium cans, all of which are simply compacted to reduce their volume.

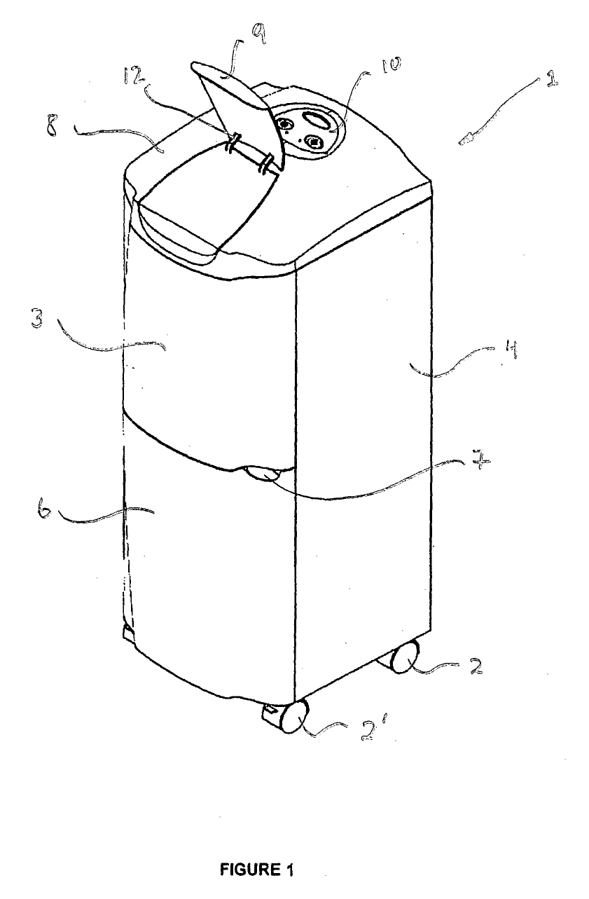

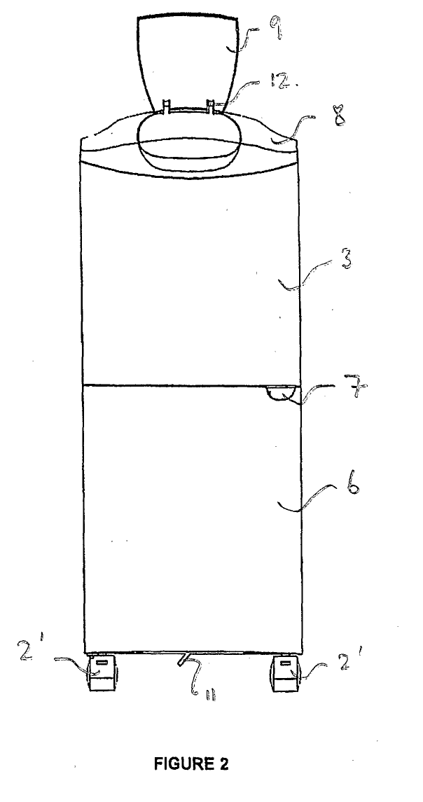

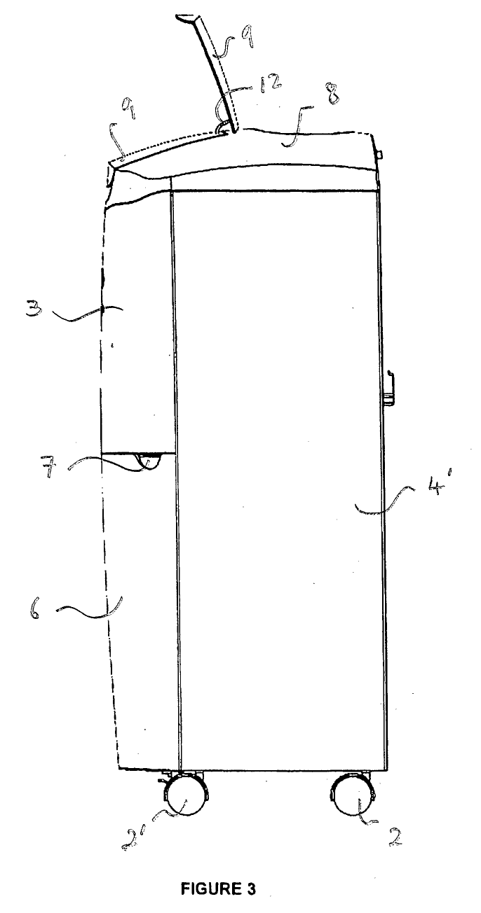

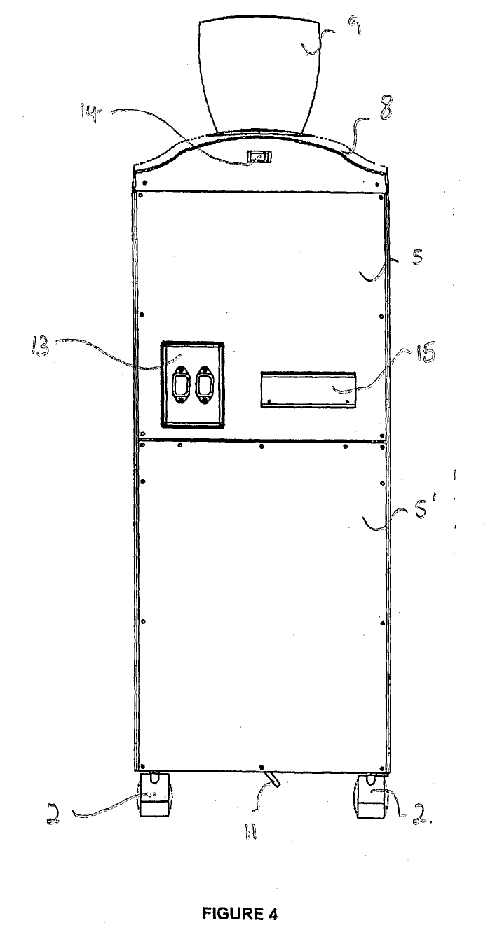

Referring to FIGS. 1, 2, 3, 4 and 5 the external and some internal features of an article compaction apparatus (1) according to the present invention are illustrated. The article compaction apparatus (1) is rendered mobile by means of castors (2, 2′)) located at the bottom of the apparatus. These castors (2, 2′) may be lockable and in the illustrated apparatus it is the front pair of castors (2′) that are lockable. The exterior of the apparatus (1) is defined by a series of panels; namely a front panel (3), two side panels (4, 4′ not shown), and two rear panels (5, 5′), which are attached to each other and internal plates (not shown) by means of appropriate brackets and internal framework. With reference to FIGS. 1 and 2 there is a front panel (3) behind which, is located the actuation mechanism sub-assembly (not shown), and side panels (4, 4′ not shown) one on each side of the apparatus (1). In addition the apparatus (1) has a hinged door (6), which provides access to the collection bin and accommodating areas (not shown). The door (6) has a handle (7) located to the right of the door (3). At the top of the apparatus (1) is a lid assembly (8), which has an access lid (9) attached thereto and which also houses some of the electronic components of the apparatus (not shown). The lid (9) is shown in both the open and closed positions in the assembly (8). Various indicators and switches (10) are located in the lid assembly (8). Also illustrated in FIGS. 2 and 4 is the interlock (11) associated with the collection bin (not shown). The access lid (9) is hinged at its furthest point (12) from the front of the apparatus (1) so that access to the compaction zone (not shown) is from the front of the apparatus (1). Also illustrated in FIG. 4 are the power sockets (13), power on switch (14) and a cord bracket (15) for the power cord.

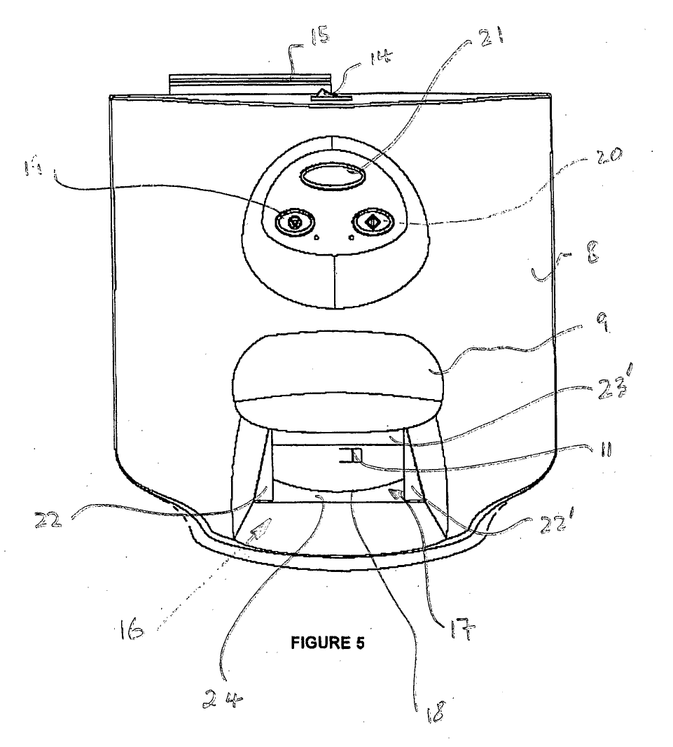

With reference to FIG. 5, the lid assembly (8) is shown with the access lid (9) open exposing the compaction zone (16) and some of its features. When looking from above into the compaction zone (16), there is a line of sight through the apparatus (1) to the collection zone (17) and collection bin (18) below the compaction zone (16). On top of the lid assembly (8) is a control panel (10), which has; stop (19) and start (20) buttons and a status indicator (21). Within the compaction zone (16) the two movable curtains (22,22′) are visible as is the bottom plate (23) for the actuation mechanism sub-assembly (not shown), which provides a ledge (23′) for supporting cans and bottles in the non-crushed state and a hole (24), which is in communication with the collection bin (18), which is located below the compaction zone (16). The dimensions of the hole (24) are such that any can or bottle placed in the compaction zone (16) cannot pass through the hole (24) when they are placed into the compaction zone (16) in their non-compacted state. However the dimensions are such that when the can or bottle is compacted they can pass through the hole (24) and into the collection bin (18). Although not visible in this figure the hole (24) is wider than the distance between the two movable curtains (22, 22′). Also visible in this figure is the collection bin (18) and the top of the interlock (11) for the collection bin (18).

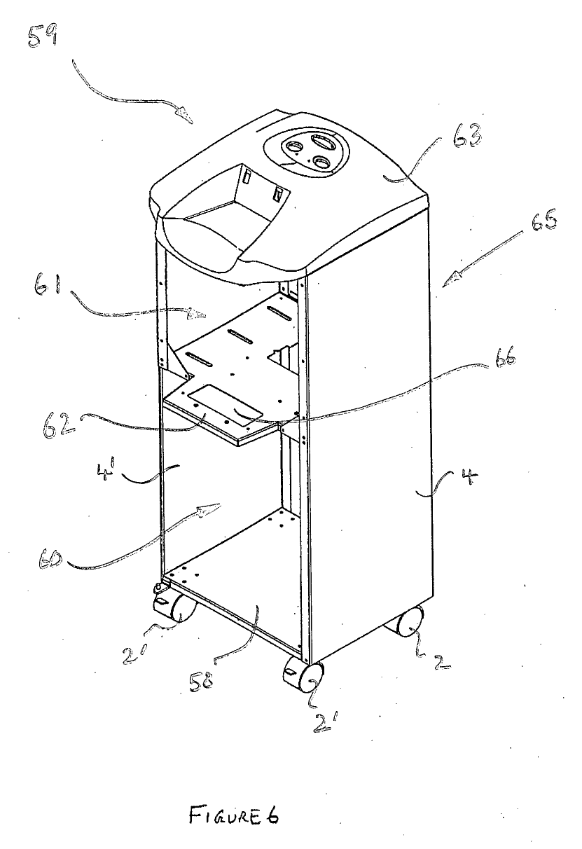

Referring to FIG. 6, the shell of the compaction apparatus (1) is shown without the internal components. The shell (59) is of simple construction and has three main sections. The lower section (60) is where the collection bin (18) is located. The bottom of the shell (59) has a floor plate (58) to which the castors (2, 2′) and side panels (4, 4′) are attached. The middle section (61), which is separated from the lower section (60) by the middle plate (62), is where the compaction mechanism sub-assembly is located. Above the middle section (61) is the top cover (63), which houses the access lid (9) and various switches and electronic components. Electronic switch and control components may be housed in the other sections also. The various panels are secured to each other by means of the various brackets and other securing means around the shell (59). This shell (59) construction is both lightweight and robust. The structure enables ease of assembly of the compaction apparatus during its manufacture. The compaction mechanism sub-assembly may easily be introduced from the back (65) of the shell (59) prior to enclosure with the back panels (5, 5′) and front panel (3). It can bee seen that the middle plate (62) has a hole (66) of rectangular cross-section located towards the front of the plate (62). This hole (66) is aligned with a corresponding hole (24) on the bottom plate (23) of the actuation mechanism the sub-assembly. The shell (59) and its components and side panels may be manufactured from sheet metals, plastics or any other suitable material.

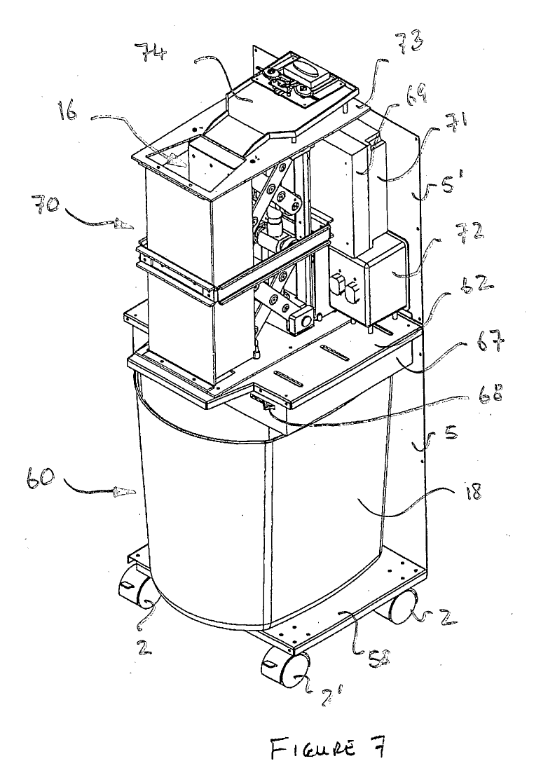

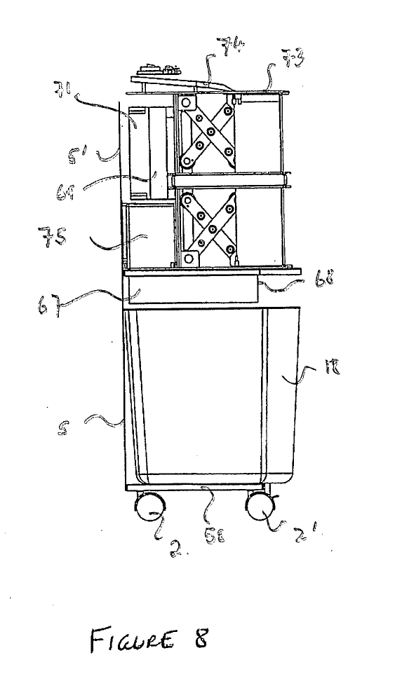

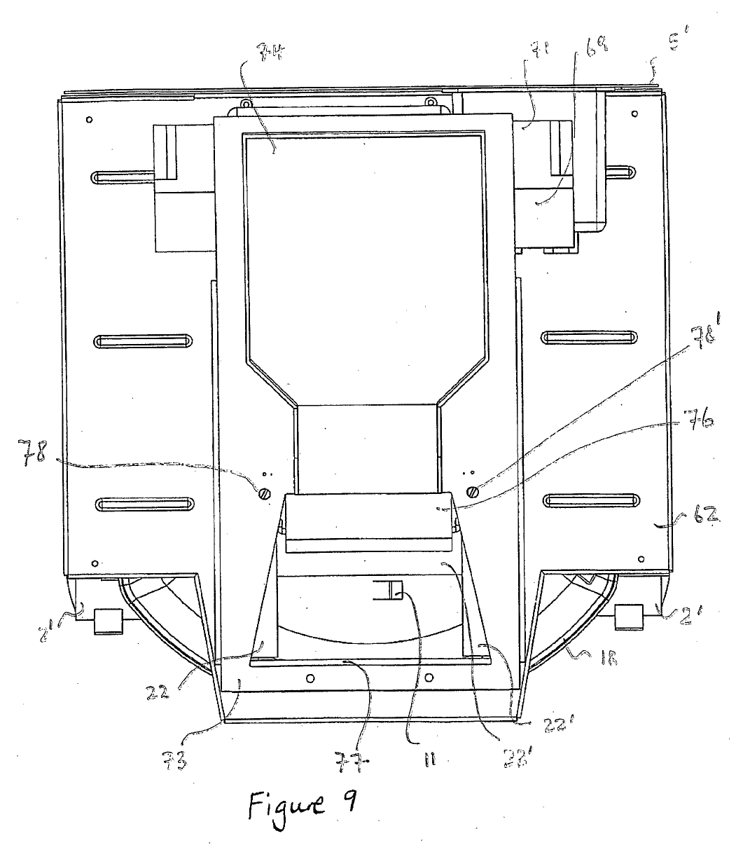

Referring to FIGS. 7, 8 and 9 the relationship of the key internal components of the compaction apparatus (1) can be seen. The collection bin (18) is located in the lower section (60) and sits on the floor plate (58). A sensor cover (67) with micro-switch (68) is located below the middle plate (62) and just above the collection bin (18). This houses the sensor for determining that bin door (3) is in the open or closed position through activation by the door of the micro-switch (68). The compaction mechanism sub-assembly (70) is located above and sits upon the middle plate (62). This assembly (70) will be described in more detail below. Behind this assembly (70) there can be seen a PCB box (69) and its cover (71) in which is housed a PCB with microprocessors for apparatus control. Also shown is the socket holder (72) for power sockets to the apparatus (1). Sat above and upon the top supporter (73) of the compaction sub-assembly (70) is a shield (74), which has a sloping surface, which slopes towards the compaction zone (16) of the apparatus (1). This shield (74) acts to protect the sensitive components of the lid assembly (not shown) from material being ejected from or misplaced in relation to the compaction zone (16), which may enter the lid assembly via the lid hinges. Also shown in FIG. 8 is the motor housing (75). FIG. 9 also illustrates the relationship between the fixed shield (74), which sits upon the top supporter (73) of the compaction mechanism sub-assembly (70) and the movable shield (76), which moves forward when the movable compaction surface (not shown) moves towards the fixed compaction surface (77). The movable shield (76) is only partially shown in this figure, as part of the shield (76) is underneath the top supporter (73) and only visible when the movable compaction surface moves towards the fixed compaction surface (77). Also shown are the pivot points (78, 78′) for the two movable curtains (22, 22′).

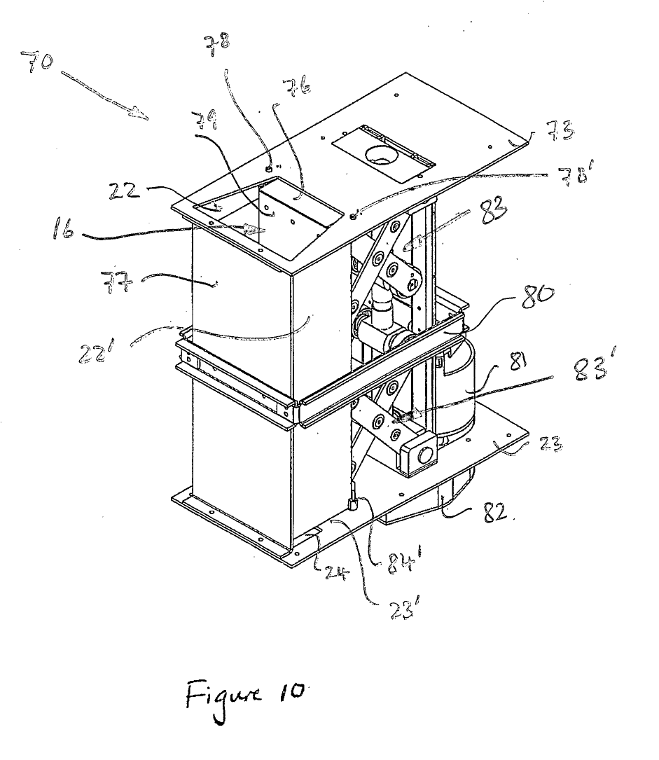

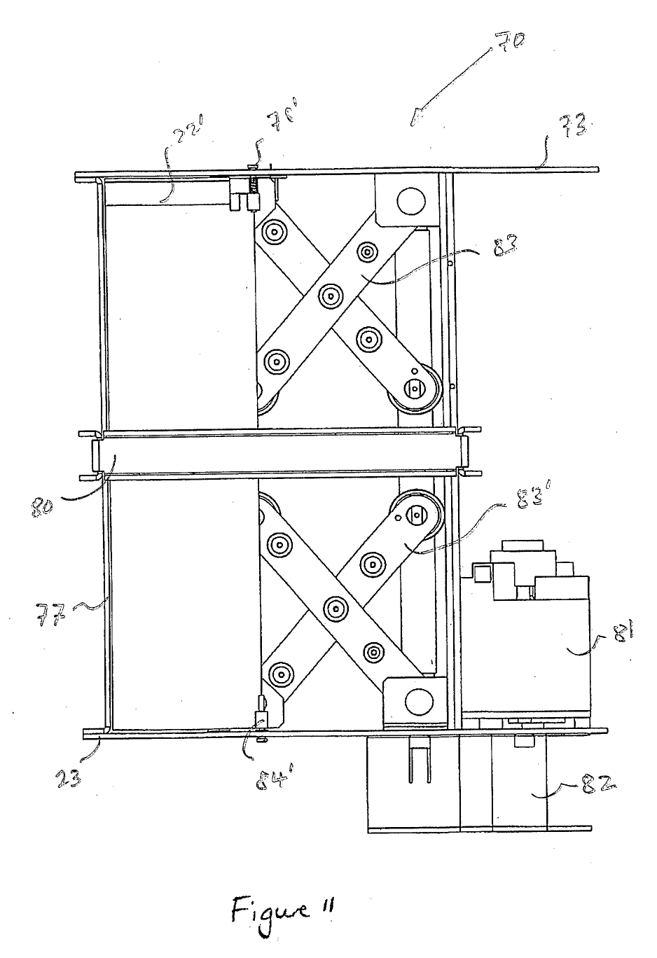

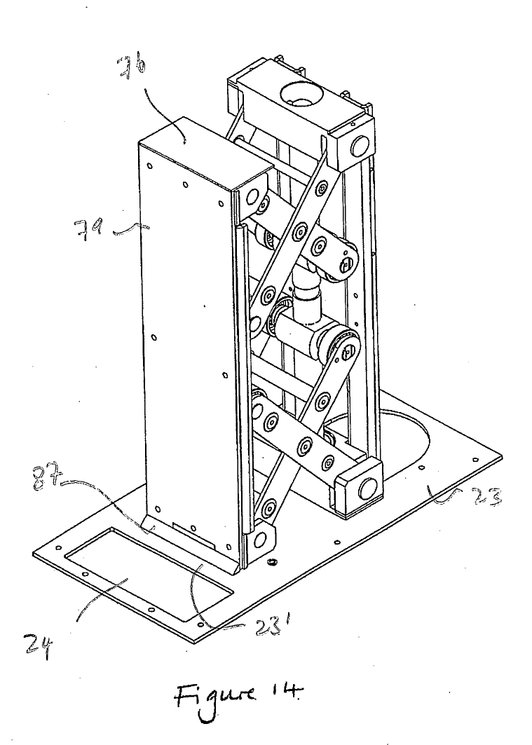

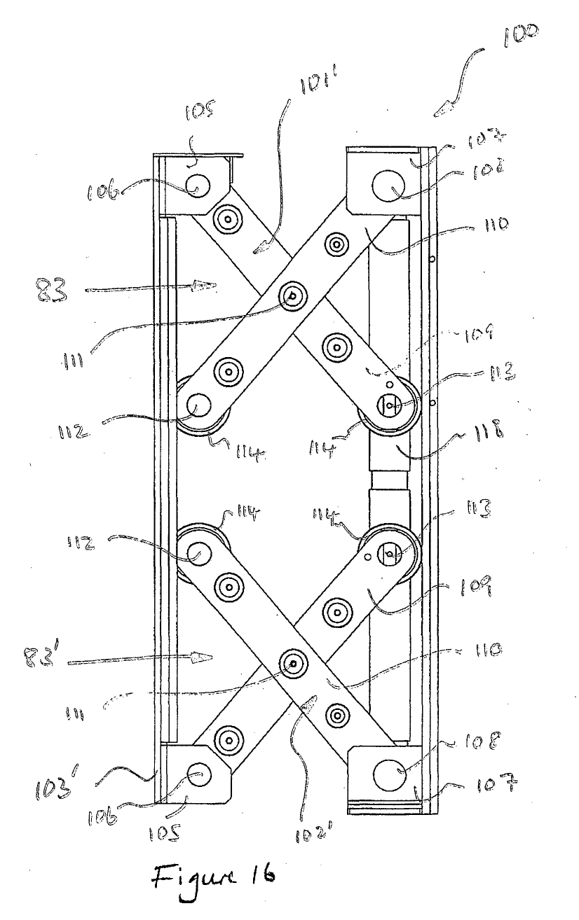

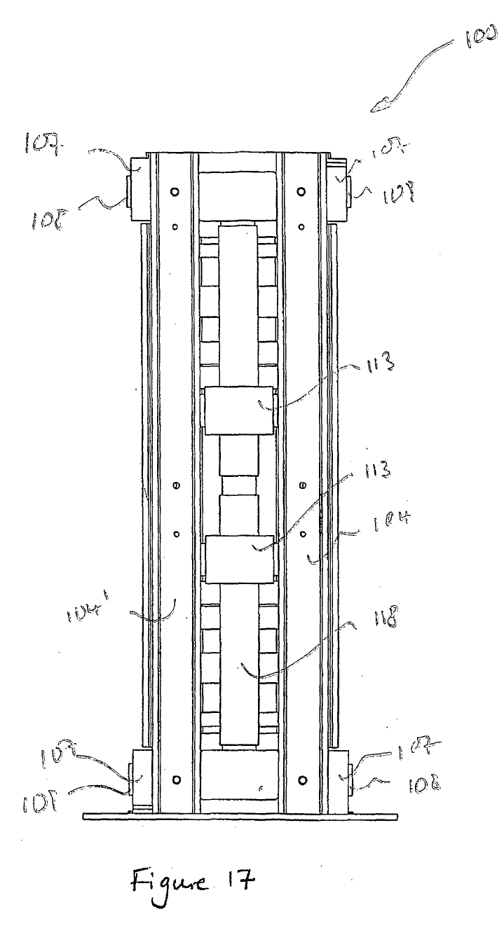

FIGS. 10, 11, 12, 13, 14, 15, 16 and 17 show the key components of the compaction mechanism sub-assembly (70). The sub-assembly (70) consists of a bottom plate (23) with hole (24), a top supporter (73), a fixed compaction surface (77), a movable compaction surface (79), a movable shield (76), two movable non-compaction surfaces (22,22′), a brace (80), a drive motor (81), a drive gearbox (82) and in this illustration two scissor jack units (83,83′) on located in vertical alignment one above the other. The bottom plate (23) with hole (24), the fixed compaction surface (77), the movable compaction surface (79) and the two movable non-compaction surfaces (22, 22′) together define the compaction zone (16) between them. The gearbox (82) is located in a plane, below the compaction zone (16) but not directly below the zone (16).

It can be seen that the two movable non-compaction surfaces (22, 22′) are hinged (78.78′) with the top supporter (73) and hinged (84, 84′) with the bottom plate (23) proximate to the movable compaction surface (79). These movable non-compaction surfaces (22, 22′) may be able to rotate about these pivot points (78, 78′, 84, 84′) so that the ends of these surfaces (85, 85′) proximate to the fixed compression surface (77) may move away from each other during the compaction process or when the apparatus is without power under manual load when cleaning the compaction zone (16) or removing debris from the compaction zone (16). The direction of these movements is indicated by double headed arrows x and y. Each pivot point (78,78′, 84, 84′) may be associated with a torsion spring (86), which biases the movable non-compaction surfaces (22,22′) towards each other. These surfaces (22, 22′) come to rest against the corresponding edges of the movable compaction surface (79) and so in the fully biased position are held approximately perpendicular to that surface. When pressure is applied to the movable non-compaction surfaces (22,22′) during compaction by the compacted can or bottle the force is such that this overcomes the bias of the torsion spring (86) and the movable con-compaction surfaces (22,22′) move away from each other and into the full biased position. Thus during use these movable non-compaction surfaces (22, 22′) enable the compaction zone (16) to expand in a specific way to accommodate the dimensions of the compacted can or bottle.

Also illustrated is the wedge shaped section (87) at the bottom of the movable compaction surface (79). This section (87) ensures the compacted material is unable to be forced under the lower edge of the movable compaction surface (79) during compaction. During compaction the wedge shaped profile (87) forces compacting material up and away from this edge.

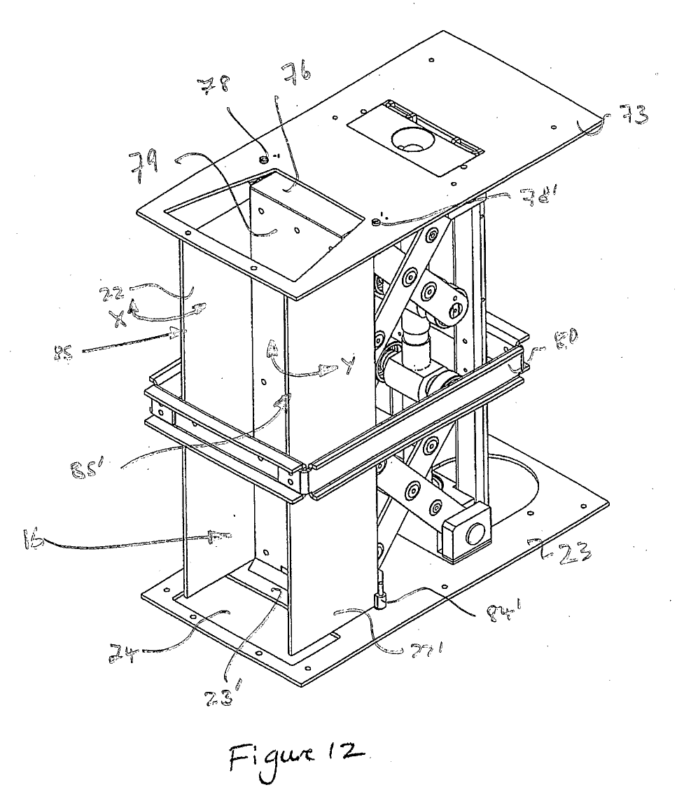

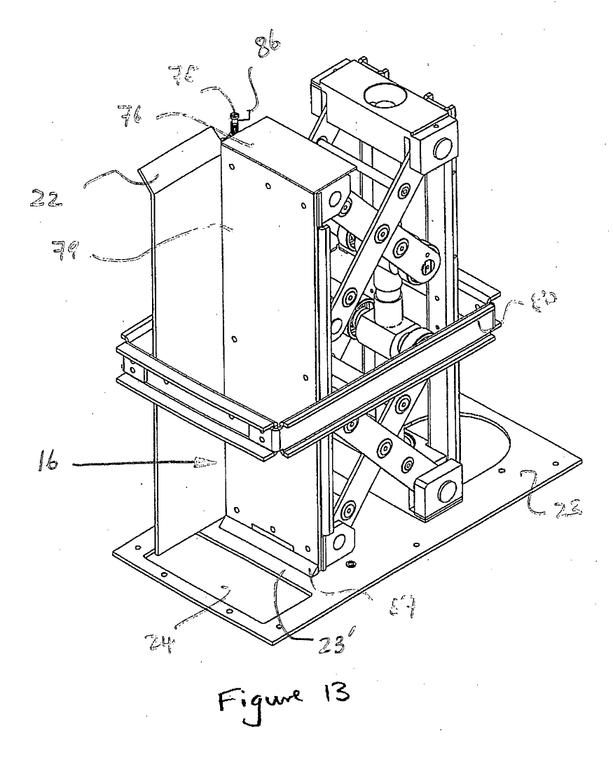

Also clear from FIGS. 12 and 13 is the relative location of the bottom plate hole (24) to the movable compaction surface (79), the movable non-compaction surfaces (22, 22′) and the ledge (23′) within the compaction zone (16). These components are of a size and are of relative proportions to provide a compact and effective compaction zone (16) for compacting aluminium cans and plastic drinks bottles. The dimensions of the zone (16) in relation to the ledge (23′) and the hole (24) are critical to ensure effective compaction and smooth utilization of the apparatus (1). As can be seen in these figures that hole (24) in the bottom plate (23) is arranged to be towards the front of the compaction zone (16) and adjacent the fixed compaction surface (77). In addition its dimensions are such that non-compacted aluminium can or plastic bottle is unable to pass from the compaction zone (16) through the hole (24). In the pre-compaction position the movable compaction surface (79) is far enough away from the hole (24) to define a ledge (23′) on the bottom plate (23) and within the compaction zone (16). During compaction an article to be compacted is placed in compaction zone (16). It is held within the zone (16) and in the upright position by the ledge (23′) and the confined space defined by the movable (79, 22.22′) and non-movable (77) surfaces. As the movable compaction surface (79) moves towards and contacts the article the article is pushed towards and makes contact with the fixed compaction surface (77). At this point the role of supporting the article within the compaction zone is effectively moved from the ledge (23′) to the vice action afforded by the two compaction surfaces (77, 79) acting upon the article. As the movable compaction surface (79) continues to move towards the fixed compaction surface (77) the article is steadily compacted and due to movement of article material during the compaction process its dimensions change perpendicular to the direction of compaction and expand such that its edges touch with and apply force to the movable non-compaction surfaces (22,22′). At this point this contact force is sufficient to overcome the torsion spring bias (86) and the movable non-compaction surfaces (22, 22′) move away form each other and allow the compaction zone (16) to effectively expand. As the compaction cycle continues the point of complete compaction is reached. At this point the movable compaction surface (79) is proximate to the fixed compaction surface (77) and the compacted article is held above the hole (24) in the bottom plate (23) by the vice like action of these surfaces (77, 79). The movable non-compaction surfaces (22.22′) impart little if any supporting fore to the compacted article. The dimensions of the compacted article are such that it could pass though the hole (24) in the bottom plate (23) if released and into the collection bin (18) below. As the compaction cycle moves to the next phase the movement of the movable compaction surface (79) is reversed and the compacting surfaces (77,79) move apart and the compacted article is able to pass from the compaction zone (16) through the hole (24) and into the collection bin (18) under the action of gravity. As the compacted article leaves the compaction zone (16) the movable non-compaction surfaces (22, 22′) pivot back to their pre-compaction position as does the movable compaction surface (79).

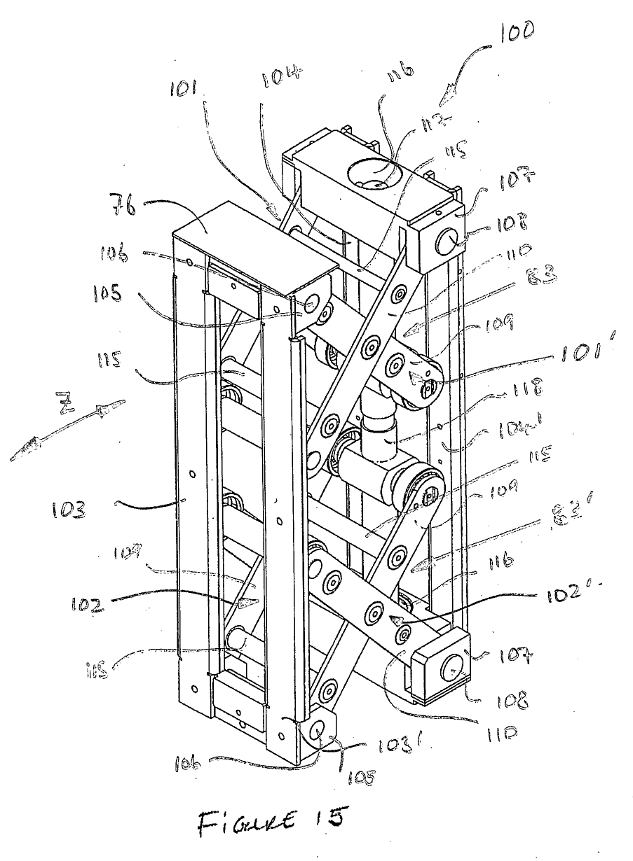

Referring to FIGS. 15, 16 and 17, the actuation mechanism (100) consists of two scissor jack units (83, 83′) arranged to operate horizontally within the apparatus (1). Arranged to operate horizontally means that the units expand and contract providing force along the axis z illustrated in FIG. 15. In this embodiment the scissor jack units (83, 83′) are arranged vertically one above the other. Each unit (83, 83′) has two scissor jack mechanisms (101,101′ and 102,102′); these are in parallel alignment to each other. It is equally possible that the mechanisms (83, 83′) could be arranged in series one next to each other. It is also possible for the vertical arrangement to be rotated through 90 degrees compared to the illustrated arrangement. In each of these alternatives there may be consequential modifications to the drive mechanism for each scissor jack unit. In the illustrated arrangement the actuation mechanism (100) has two moving paths (103,103′), which are in contact with the back of movable compaction surface (not shown). These moving paths (103,103′) are parallel to each other and are able to move with the movable compaction surface (79). On the opposite side of the mechanism are located two fixed paths (104,104′). These are parallel to each other and in fixed relationship with the fixed compaction surface (not shown); this being achieved by means of the brace (80). Between the moving paths (103,103′) and fixed paths (104, 104′) is located two scissor jack units (83, 83′).

Each scissor jack unit (83, 83′) consists of a fixed lever block (105) with long fixed shaft (106), a fixed block (107) with short fixed shaft (108), an inside scissor arm (109) an outside scissor arm (110), a fixed middle shaft (111), a long moving shaft (112), a short moving screw shaft (113), ball bearings (114), inside and outside traverse bars (115). The moving paths (103,103′) are fixed to the fixed lever block (105) of each scissor mechanism at their ends such that the fixed lever blocks (105) of each scissor mechanism are remote from each other. The fixed paths (104, 104′) are fixed to the fixed block (107) of each scissor mechanism at their ends such that the fixed blocks (107) of each scissor mechanism are remote from each other. The fixed blocks (107) each has a passage (116) to accommodate the ends (117) of a threaded screw (118). Each scissor mechanism has a short mounted screw shaft (113), which has a threaded, bore through which the threaded screw (118) is located. Each short mounted screw shaft (113) may move relative to the threaded screw (118), as it is it is rotated. Each short mounted screw shaft (113) has a ball bearing (114) at each end; the ball bearing (114) is located within and can travel along the parallel fixed paths (104, 104′). At each end of the short mounted screw shaft (113) is attached an inside scissor arm (109) in pivotal relationship therewith. The opposite end of each inside scissor arm (109) is attached in pivotal relationship to the long fixed shaft (106) of the opposing fixed lever block (105). Each outside scissor arm (110) is attached to the short fixed shaft (108) of the fixed block (107). The opposite end of each outside scissor arm (110) is attached to a long moving shaft (112), which also accommodates a ball bearing (114), which is located within its corresponding moving path (103,103′). Corresponding inside (109) and outside scissor arms (110) are connected to each other and to the adjacent pair of scissor arms through a fixed Middle shaft (111) about which the may rotate relative to each other. It can be seen therefore that each scissor jack mechanism has two pairs of scissor arms arranged parallel with each other and connected with each other at each scissor arm end via the short fixed shaft (108), the short moving screw shaft (113), a long fixed shaft (106) and long moving shaft (112) in addition to the fixed middle shaft (111). In addition various transverse bars (115) are used to provide additional rigidity and robustness to the mechanism.

During operation the threaded screw (118) is rotated via the gearbox (82) by the electric drive (81). This rotation causes each short moving screw shaft (113) to move relative to the threaded screw (118). In the illustrated arrangement the threaded screw (118) has two separately and oppositely threaded sections so that the short moving screw shafts (113) move away from each other. The fixed scissor arm ends remain fixed in relation to the moving paths (103,103′) and the fixed paths (104, 104′) but the opposing ends of these scissor arms, which have ball bearings (114), are free to move within the moving and fixed paths (104, 104′). The short moving screw shafts (113) move along their respective fixed paths (104, 104′) towards their respective fixed blocks (107) and as each pair of scissor arms is fixed relative to each other about the fixed middle shaft (111) this causes the ends of the scissor arms remote from the fixed paths (104, 104′) to move away from the fixed paths (104, 104′). This movement exerts pressure to the moving paths (103,103′), which are forced away from the fixed paths (104, 104′). As the moving paths (103,103′) are fixed to the moving compaction surface (79) and the fixed paths (104, 104′) are in fixed relationship with the fixed compaction surface (77) this scissor action causes the movable compaction surface (79) to approach the fixed compaction surface (77). Once the compaction cycle is complete reversing the rotation of the threaded screw (118) causes the mechanism to move back to the original position.

Various means for limiting or controlling movement of the movable compaction surface (79) to the fixed compaction surface (77) may be employed. For example, the control means may be programmed to set various limits for the movement of the threaded screw (118). The limits may be set to determine a fully open and a fully closed position. Intermediate positions between these two extremes can also be set to correspond to the best crush dimensions for each apparatus and article to be compacted. In this arrangement, the control means will include an input means enabling the user to select a particular compaction programme for the type of article to be compacted and the control means will monitor the position of the compaction surfaces (77, 79) and limit movement accordingly. Any suitable means for detecting the various limits can be used. In a preferred embodiment, the fully open and fully closed positions are detected using limit switches, whilst intermediate limits are detected by means of a rotational sensor (not shown) on the gearbox output shaft. The rotational sensor being arranged to provide an input to the control means indicative of the position of the movable compaction surface (79). The control means may also include an overload limit to prevent the compaction surfaces (77, 79) from jamming, or the drive mechanism being damaged, by stopping and reversing the movement when an overload is detected. The overload limit may be detected by means of the rotational sensor on the gearbox output shaft. Alternatively, the current drawn by the motor can be measured and used to detect an overload condition. A further possible alternative is to provide force sensors to monitor the forces applied by the compaction surfaces and the control means may be programmed to ensure that the forces do not exceed a predetermined limit.

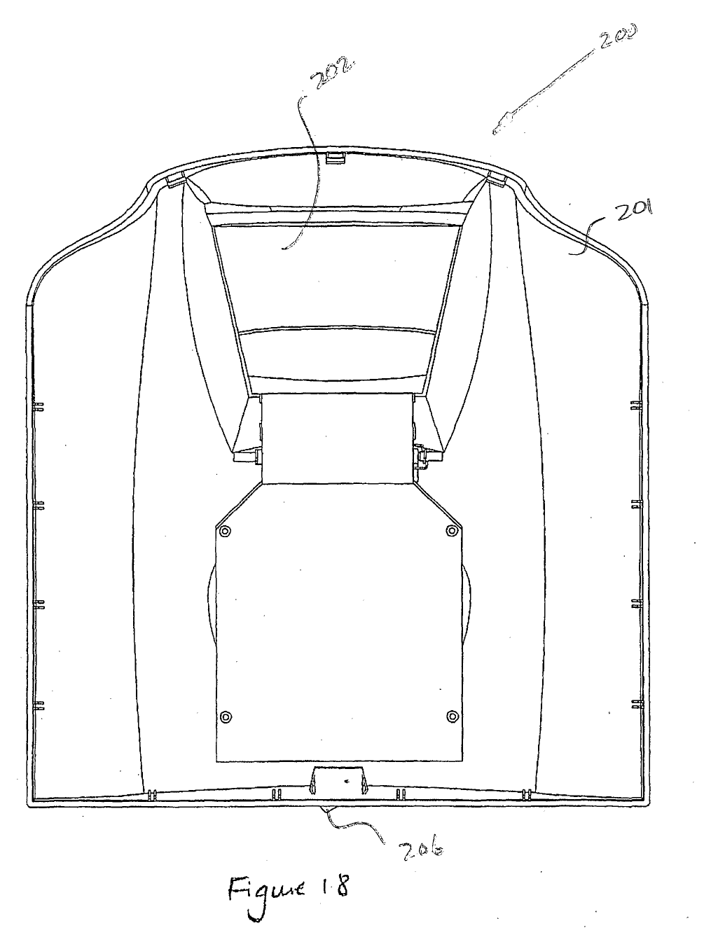

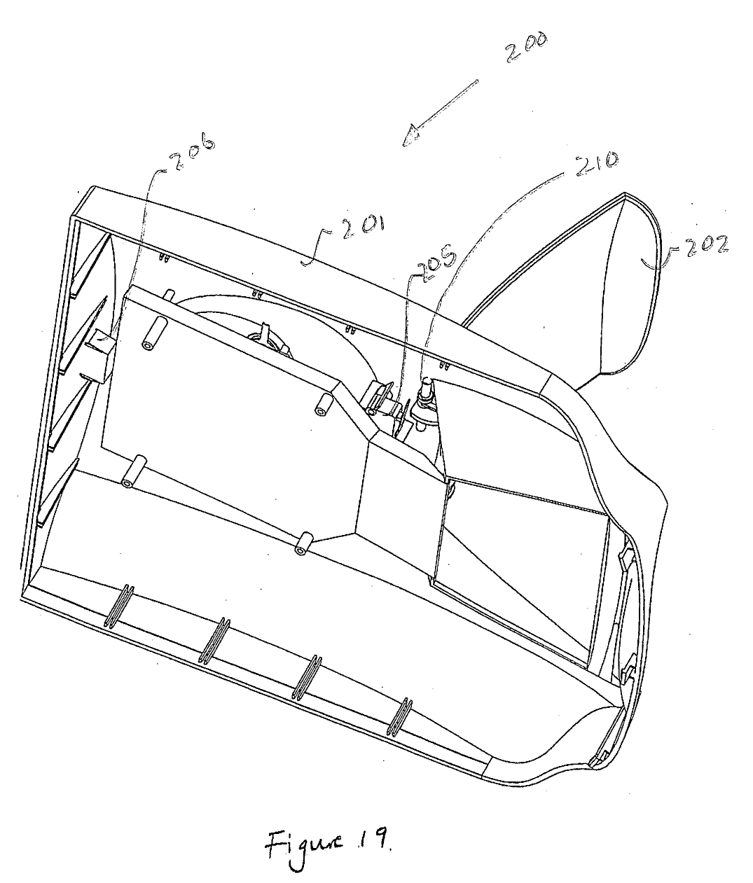

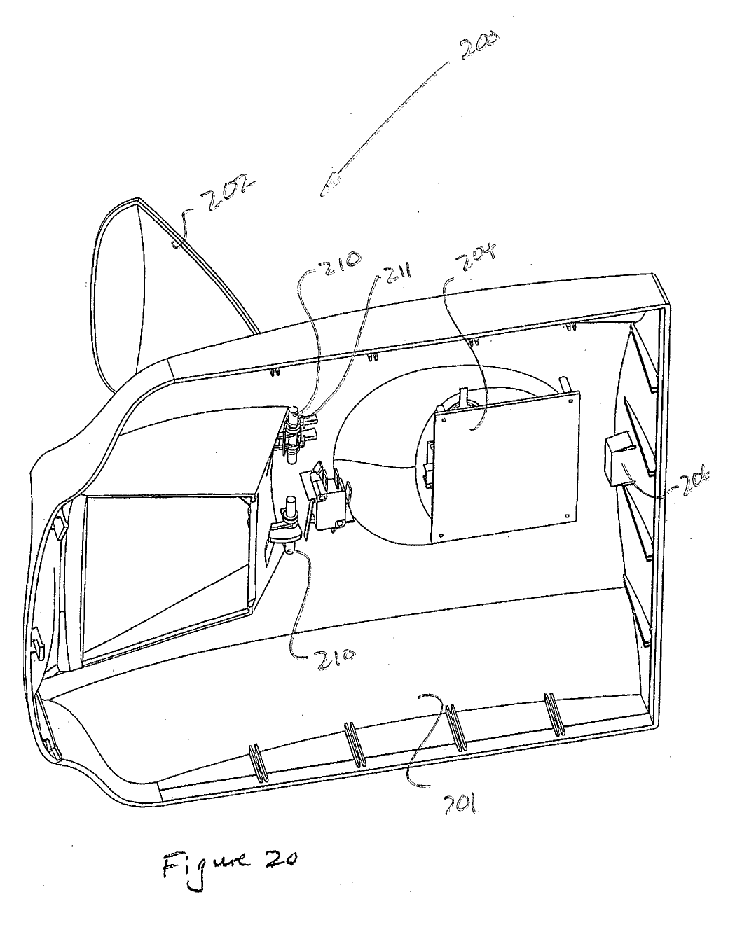

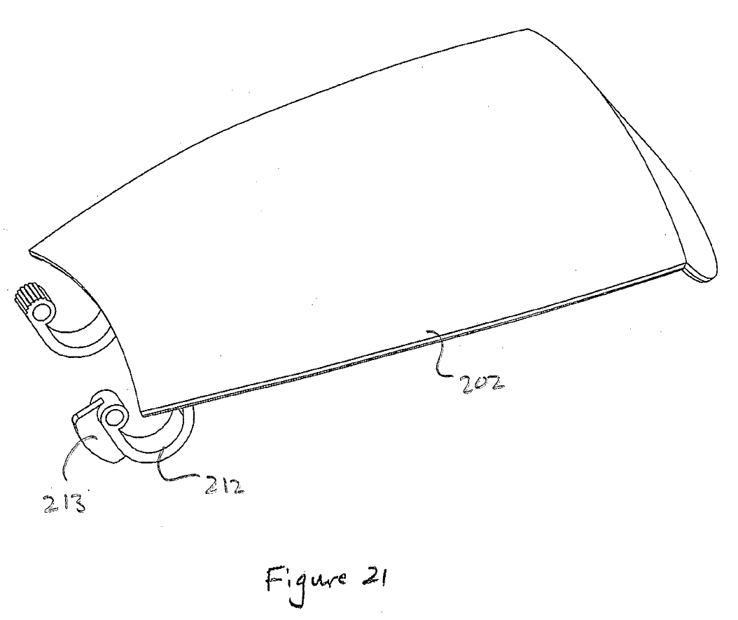

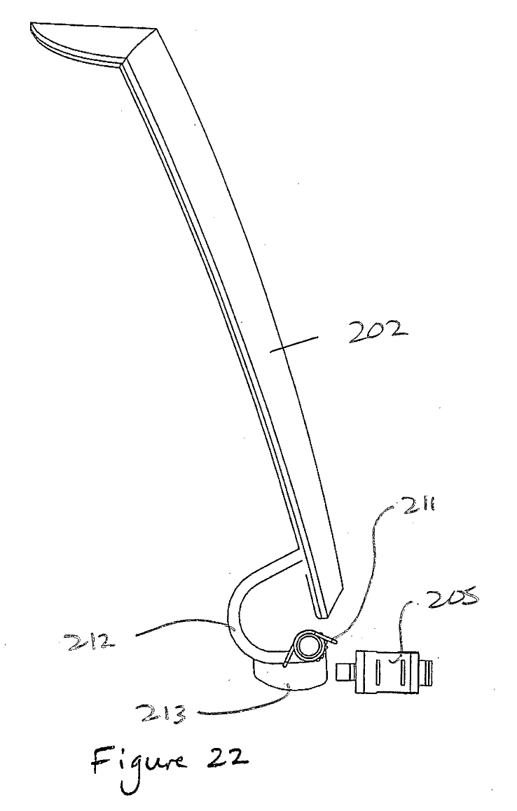

Referring to FIGS. 18, 19, 20 illustrate the key components of the top cover assembly (200). This assembly (200) consists of a top cover housing (201), a hinged access lid (202), a PCB (not shown) with PCB plastic mount (204), activation (not shown) and deactivation (not shown) buttons, a lens indicator (not shown) a micro-switch (205), a power switch (209), hinge shafts (210), and a hinge spring (211). The PCB is arranged to interact with the activation and deactivation buttons and to provide visual indication of button status from the top of the assembly through the use of the lens. A key component of the top cover assembly is the spatial relationship between the hinged lid (202) and micro-switch (205) and the hinged lid design. This is shown in more detail FIGS. 21 and 22.

The micro-switch (205) is located proximate to the top cover opening but as far away as possible from the front edge of that top cover opening. In addition the micro-switch (205) is concealed within a relatively enclosed section of the top cover being the underside of the top surface of the top cover and proximate to a lid hinge opening. In this location the micro-switch (205) is relatively secure from damage due to ingress of liquids from articles to be compacted or material from compacted articles. The top cover is designed to provide this level of protection. In addition the design enables the micro-switch (205) to be proximate to and actuated by a hinged arm (212) of the access lid (202). The access lid (202) has a hinged arm (212) which is adapted to actuate the micro-switch (205). This adaptation takes the form of a cam section (213) arranged to rotate with the rotation of the hinge and to impart the cam action in the same plane of rotation. The micro-switch (205) is arranged so that its switch mechanism may be activated by this cam action.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention as defined by the claims.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An article compaction apparatus comprising a fixed compaction surface and a movable compaction surface substantially parallel to the fixed compaction surface, the movable compaction surface being movable relative to the fixed compaction surface by means of an actuation mechanism, wherein the actuation mechanism comprises at least one scissor jack unit arranged for horizontal operation within the apparatus.

2. An article compaction apparatus as claimed in claim 1 comprising a plurality of scissor jack units arranged for horizontal operation within the apparatus.

3. An article compaction apparatus as claimed in claim 2 wherein the plurality of scissor jack units are in vertical alignment within the apparatus.

4. An article compaction apparatus as claimed in claim 3 wherein there are two scissor jack units in vertical alignment within the apparatus.

5. An article compaction apparatus as claimed in claim 1 wherein the scissor jack unit(s) comprise at least one scissor jack mechanism having at least one pair of scissor arms that move within a vertical plane within the unit.

6. An article compaction apparatus as claimed in claim 1 wherein the scissor jack mechanisms of each unit are driven by individual drive means.

7. An article compaction apparatus as claimed in claim 1 wherein the scissor jack mechanisms within a unit are driven by a common drive means.

8. An article compaction apparatus as claimed in claim 1 wherein a plurality of scissor jack units are driven by a common drive means.

9. An article compaction apparatus as claimed in claim 1 wherein a drive shaft in communication with the scissor jack unit or scissor jacks units runs in parallel alignment with the compaction surfaces.

10. An article compaction apparatus as claimed in claim 1 wherein each scissor jack mechanism within the unit has a pair of scissor arms, and wherein the ends of the scissor arms remote from the drive shaft are in contact with but are not fixed to the rear of the movable compaction surface.

11. An article compaction apparatus as claimed in claim 10 wherein at least one of the scissor arms remote from the drive shaft is in fixed engagement with the rear of the movable compaction surface.

12. An article compaction apparatus as claimed in claim 10 wherein at least one of the scissor arms, which is not in fixed engagement with the movable compaction surface is terminated with a ball bearing arrangement, which is in movable contact with the rear of the movable compaction surface.

13. An article compaction apparatus as claimed in claim 10 wherein the scissor arms remote from the drive shaft are engaged within guide means on the rear of the movable compaction surface.

14. An article compaction apparatus as claimed in claim 13 wherein the ends of the scissor arms are engaged within the guide means which is in the form of a slot towards the rear of the movable compaction surface.

15. An article compaction apparatus as claimed in claim 13 wherein the ball bearing arrangement sits within the guide means.

16. An article compaction apparatus as claimed in claim 10 wherein each scissor jack mechanism within the unit has a pair of scissor arms, one of which is pivotally fixed with the rear of the movable compaction surface and a corresponding arm, which' is not fixed with the rear of the movable compaction surface and may move in pivotal relation with the fixed arm and the rear of the movable compaction surface.

17. An article compaction apparatus as claimed in claim 1 wherein each scissor jack mechanism within the unit has a pair of scissor arms and wherein the scissor arm ends remote from the movable compaction surface are in cooperative engagement with a fixed static point within the apparatus.

18. An article compaction apparatus as claimed in claim 1 wherein the actuation mechanism comprises a threaded screw drive means.

19. An article compaction apparatus as claimed in claim 18 wherein movable scissor arm ends associated with a fixed static point in the apparatus are secured to the threaded screw by means of a movable screw shaft.

20. An article compaction apparatus as claimed in claim 18 wherein non-movable scissor arm ends are pivotally secured relative to the threaded screw by means of a fixed block through which the threaded screw may pass.

21. An article compaction apparatus as claimed in claim 1 wherein each scissor jack mechanism within a scissor jack unit has a fixed middle point about which parallel pairs of scissor arms may pivot.

22. A double scissor jack unit comprising two scissor units sharing a common drive means, a common fixed static point and common guide means.

23. An article compaction apparatus comprising a fixed compaction surface and a movable compaction surface substantially parallel to the fixed compaction surface, the movable compaction surface being movable relative to the fixed compaction surface by means of an actuation mechanism, wherein the movable compaction surface comprises a wedge shaped section at the bottom of the movable compaction surface.

24. An article compaction apparatus comprising a fixed compaction surface and a movable compaction surface substantially parallel to the fixed compaction surface, the movable compaction surface being movable relative to the fixed compaction surface by means of an actuation mechanism, wherein the access point for waste to be compacted is located at the top of the compaction zone, the actuation mechanism comprises at least one scissor jack unit arranged for horizontal operation within the apparatus and, located below the compaction zone there is located compacted waste collection means.

25. An article compaction apparatus as claimed in claim 24 wherein the compaction zone comprises means to secure the waste within the compaction zone prior to compaction and means to enable the compacted waste to pass to the compacted waste collection means.

26. An article compaction apparatus as claimed in claim 25 wherein the means to enable the compacted waste to pass to the compacted waste collection means allows the compacted waste to pass to the collection means under the force of gravity.

27. An article compaction apparatus as claimed in claim 25 wherein the means to secure the waste within the compaction zone prior to compaction and means to enable the compacted waste to pass to the compacted waste collection means is a bottom plate upon which the scissor jack unit or units and compaction zone are supported and which separates these from the collection means.

28. An article compaction apparatus as claimed in claim 27 wherein the bottom plate comprises a hole of smaller dimension than the compaction zone and which enables communication between the compaction zone and the collection means.

29. An article compaction apparatus as claimed in claim 27 wherein the dimensions of the hole are such that it is too small to allow the non-compacted waste to pass out of the compaction zone through the bottom plate and into the collection means.

30. An article compaction apparatus as claimed in claim 26 wherein the compacted waste is able to pass from the compaction zone under the force of gravity, after the pressure of compaction is released.

31. An article-compaction apparatus as claimed in claim 28 wherein the hole of the bottom plate is located proximate to the region in the compaction zone where compaction is complete.

32. An article compaction apparatus as claimed in claim 24 wherein the apparatus comprises a lid, which may be opened to enable access to the compaction zone and when closed ensures that the compaction zone is enclosed during compaction of waste.

33. An article compaction apparatus as claimed in claim 24 wherein the drive means comprises a drive motor, which is connected to the threaded screw via a gearbox arrangement or a belt and pulley arrangement.

34. An article compaction apparatus as claimed in claim 33 wherein the gearbox and/or belt and pulley arrangement drives the threaded screw from the bottom of the actuation mechanism.

35. An article compaction apparatus as claimed in claim 33 wherein the drive motor is located above the gearbox or pulley and belt arrangement.

36. An article compaction apparatus comprising an actuation mechanism for compaction, wherein the access point for waste to be compacted is located at the top of a compaction zone having a lid for access, below the compaction zone there is compacted waste collection means comprising a collection bin and access means to the collection bin, and switch control means to ensure that the actuation mechanism for compaction may not be activated when either the lid, compaction waste collection means or access means to the collection means are either present and/or in the incorrect position for safe compaction.

37. An article compaction apparatus as claimed in claim 36 wherein the switch control means comprises a micro-switch which may be activated by opening and closing of the access point lid, a micro-switch arrangement, which detects that the access means to the collection bin is secure and an interlock mechanism to ensure that the removable collection means is located within the apparatus. mechanism to ensure that the removable collection means is located within the apparatus.

38. An article compaction apparatus as claimed in claim 37 wherein the switch mechanism associated with. the opening and closing of the access point lid comprises engagement of a portion of the lid remote from the front of the compaction apparatus with a micro-switch.

39. An article compaction apparatus as claimed in claim 38 wherein the micro-switch is secured in the lid housing.

40. An article compaction apparatus as claimed in claim 38 wherein the engagement portion of the lid is associated with one or more lid arms, which secure the lid to the lid housing and about which point the lid may rotate relative to the lid housing.

41. An article compaction apparatus as claimed in claim 40 wherein at least one of the lid arms has a cam surface, which contacts the micro-switch during rotation of the access lid.

42. An article compaction apparatus comprising a fixed compaction surface and a movable compaction surface substantially parallel to the fixed compaction surface, these surfaces defining a compaction zone, the movable compaction surface being movable relative to the fixed compaction surface by means of an actuation mechanism, wherein the compaction zone is further defined by movable non-compaction surfaces substantially perpendicular to the compaction surfaces in the pre-compaction state.

43. An article compaction apparatus as claimed in claim 42 wherein the movable non-compaction surfaces are arranged to move in a pivotal relationship to the compaction surfaces during the compaction cycle.

44. An article compaction apparatus as claimed in claim 43 wherein the pivotal arrangement is remote from the fixed compaction surface.
